(19) United States
(12) Patent Application Publication
(10) Pub. No.: US 2019/0193251 A1
(43) Pub. Date: Jun. 27, 2019

(54) ATTACHMENT ASSEMBLY TO BE CONNECTED WITH A HAND TOOL

(71) Applicant: Chih-Ming Lee, Taichung (TW)

(72) Inventor: Chih-Ming Lee, Taichung (TW)

(21) Appl. No.: 15/851,740

(22) Filed: Dec. 21, 2017

(51) Int. Cl. B25B 17/02; B25B 13/48; B25B 23/00

(52) U.S. Cl. CPC B25B 17/02; B25B 23/0028; B25B 23/0021; B25B 13/481

(57) ABSTRACT

An attachment assembly for being connected with a hand tool includes an active unit, a passive unit and a shaft. The active unit includes a first base and a first cover. A front wheel, a middle wheel and a rear wheel are rotatably received in a space between the first base and the first cover in sequence. The front, middle and rear wheels are engaged with each other. The passive unit includes a second base and a second cover. A first wheel and a second wheel are rotatably received in a space between the second base and the second cover. The first and second wheels are engaged with each other. The shaft pivotably connects the active unit and the passive unit which is pivotably connected to the active unit.

### BACKGROUND OF THE INVENTION

### 1. Fields of the Invention

The present invention relates to an attachment assembly for being connected with a hand tool so as to transfer torque to objects.

### 2. Descriptions of Related Art

The conventional attachment to be used in conjunction with a ratchet wrench know to applicant is disclosed in U.S. Pat. No. 4,279,314, and comprises a housing having an internal compartment. An access opening is formed within the housing and connected with the internal compartment. A primary drive gear is rotatably mounted within the internal compartment. The primary drive gear has a socket opening centrally located within the primary drive gear. The socket opening connects with the access opening. A secondary drive gear is rotatably mounted within the internal compartment. The secondary drive gear is operatively connected through an idler gear to the primary drive gear. A spring assembly is connected to both the primary and the secondary drive gears. The spring assembly is windable by rotating the socket opening. The socket opens to connect with a socket plug. The spring assembly causes rotation of the socket plug. A movable pawl is mounted on the housing and located within the internal compartment. The movable pawl is movable between an engaging position and a disengaging position. The engaging position connects the movable pawl with one of the drive gears and prevents rotation of the socket opening by the spring assembly.

However, the attachment is a rectangular part and cannot be bent an angle when the polygonal shaped opening is connected with an object, so that the combination of the wrench and the attachment cannot be rotated in a small area. Besides, there are the idler gear, the secondary driving gear and the socket sleeve received in the attachment which has a limited room, so that when the wrench rotates the socket plug, the significant torque cannot be generated by the attachment itself. The attachment has to contact against the wrench by the pin. Furthermore, the length of the attachment is limited, when the polygonal shaped opening is connected with an object, only a limited torque is generated and this restricts the range of use of the attachment.

The present invention intends to provide an attachment unit for being connected with a hand tool so as to transfer large torque to objects.

### SUMMARY OF THE INVENTION

The present invention relates to an attachment assembly for being connected with a hand tool, and comprises an active unit, a passive unit and a shaft. The active unit includes a first base and a first cover. A front wheel, a middle wheel and a rear wheel are rotatably received in a space between the first base and the first cover in sequence. The front, middle and rear wheels are engaged with each other. The passive unit includes a second base and a second cover. A first wheel and a second wheel are rotatably received in a space between the second base and the second cover. The first and second wheels are engaged with each other. The shaft pivotably connects the active unit and the passive unit which is pivotably connected to the active unit.

The primary object of the present2invention is to provide an attachment assembly for being connected with a hand tool, wherein the active and passive units are pivotable relative to each other. The engagement between the front, rear, middle, first and second wheels provides features for different work tasks.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of the attachment assembly of the present invention;

FIG. 2 is an exploded view of the active unit of the attachment assembly of the present invention;

FIG. 3 is a perspective view to show the attachment assembly of the present invention;

FIG. 4 is a side view to show the attachment assembly of the present invention;

FIG. 5 is a cross sectional view, taken along line 5-5 of FIG. 4;

FIG. 6 shows is a cross sectional view, taken along line 5-5 of FIG. 4 to show another operational status;

FIG. 7 shows the attachment assembly of the present invention is cooperated with two hand tools;

FIG. 8 is a perspective view to show the second embodiment of the attachment assembly of the present invention;

FIG. 9 shows another operational status of the second embodiment of the attachment assembly of the present invention;

FIG. 10 is an exploded view of the third embodiment of the attachment assembly of the present invention;

FIG. 11 is a perspective view to show the third embodiment of the attachment assembly of the present invention;

FIG. 12 is an exploded view of the fourth embodiment of the attachment assembly of the present invention;

FIG. 13 is an exploded view of the active unit of the fourth embodiment of the attachment assembly of the present invention;

FIG. 14 is an exploded view of the passive unit of the fourth embodiment of the attachment assembly of the present invention;

FIG. 15 is a perspective view to show the fourth embodiment of the attachment assembly of the present invention;

FIG. 16 is a side view to show the third embodiment of the attachment assembly of the present invention;

FIG. 17 is a cross sectional view, taken along line 17-17 of FIG. 16.

### DETAILED DESCRIPTION OF THE PREFERRED EMBODIMENT

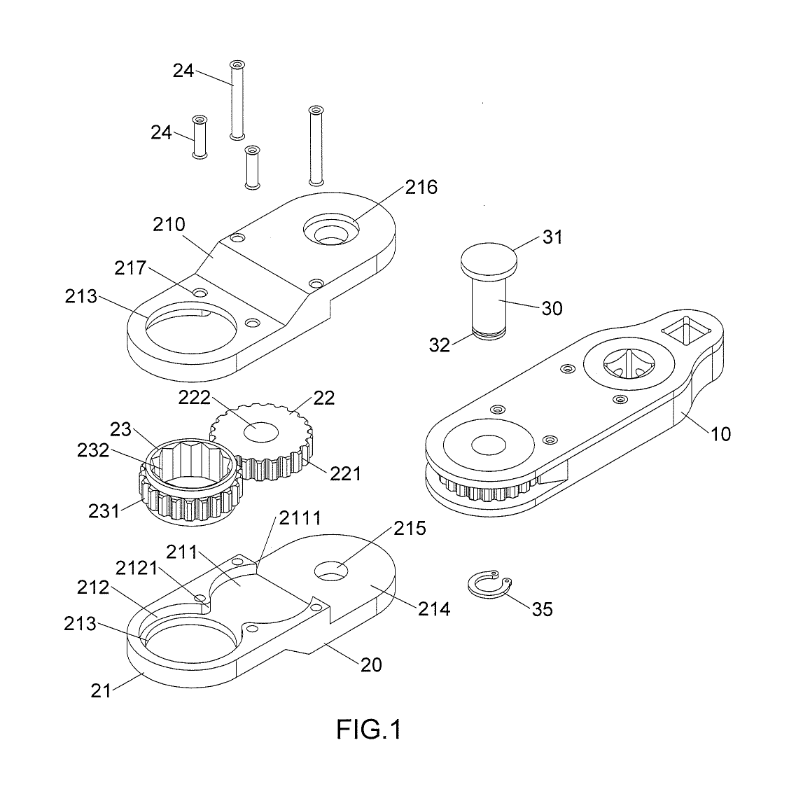

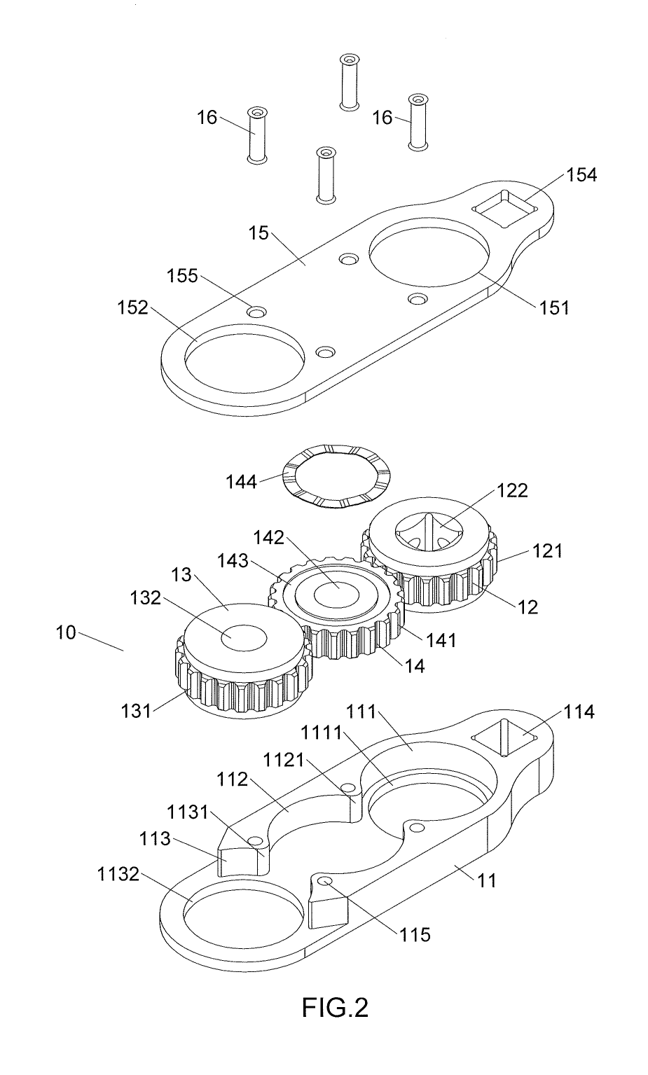

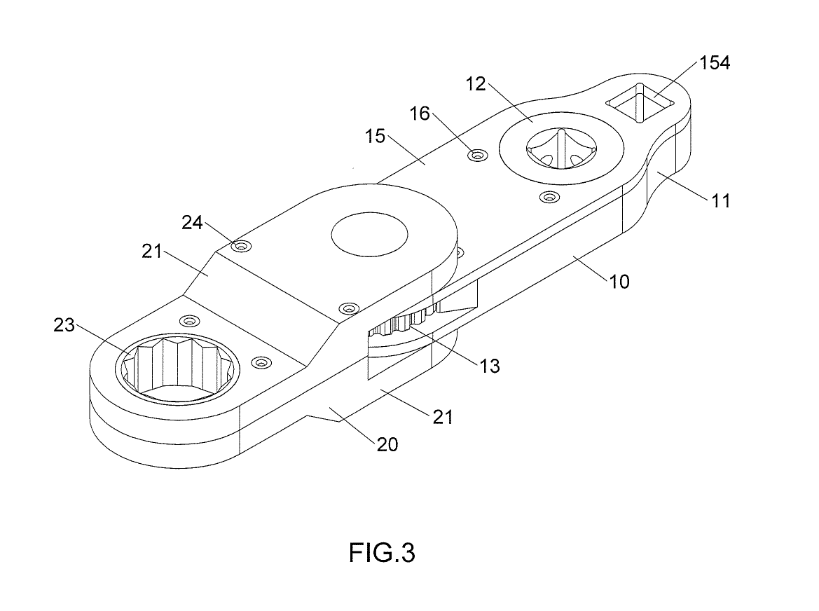

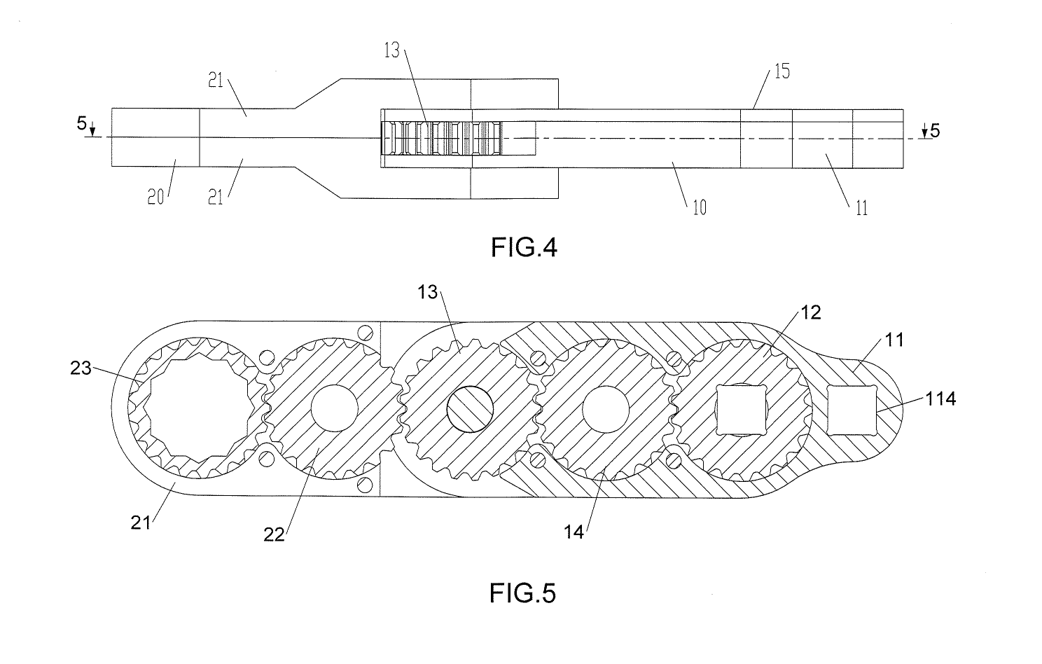

Referring to FIGS. 1 to 6, the attachment assembly of the present invention comprises an active unit 10, a passive unit 20 and a shaft 30.

The active unit 10 comprises a first base 11 and a first cover 15 which is mounted to the first base 11. Each of the first base 11 and the first cover 15 has a front end and a rear end. A front wheel 12, a middle wheel 14 and a rear wheel 13 are rotatably received in the space between the first base 11 and the first cover 15 in sequence. The first base 11 has a front recess 111, a middle recess 112 and a rear recess 113. The front recess 111 has a front pivotal hole 1111 defined through the bottom thereof. A first opening 1121 is defined in communication between the front and middle recesses 111, 112. The rear recess 113 opens to the rear end of the first base 11. A second opening 1131 is defined in communication between the middle and rear recesses 112, 113. The rear recess 113 has a rear pivotal hole 1132 defined through the bottom thereof. A first mounting hole 114 is defined through the front end of the first base 11 such that the front recess 111 is located between the first mounting hole 114 and the middle recess 112. The first base 11 includes four even-spaced locking holes 115.

The front wheel 12, the middle wheel 14 and the rear wheel 13 are respectively and rotatably received in the front recess 111, the middle recess 112 and the rear recess 113. The front wheel 12, the middle wheel 14 and the rear wheel 13 have the same diameter. Each of the front wheel 12, the middle wheel 14 and the rear wheel 13 has teeth 121/131/141 defined in an outside thereof. A polygonal engaging portion 122 is defined centrally in the front wheel 12. The teeth 121 of the front wheel 12 are engaged with the teeth 141 of the middle wheel 14 via the first opening 1121. The teeth 141 of the middle wheel 14 are engaged with the teeth 131 of the rear wheel 13 via the second opening 1131. The rear wheel 13 has an axial hole 132 defined centrally therethrough. The middle wheel 14 includes a first receiving portion 142 and an annular groove 143 located around the first receiving portion 142. A ring-shaped resilient member 144 is engaged with the annular groove 143.

The first cover 15 has two bores 151, 152 respectively located close to the front end and the rear end of the first cover 15. The two bores 151, 152 are respectively located corresponding to the front recess 111 and the rear recess 113. The front wheel 12 is rotatably engaged between the front pivotal hole 1111 and the bore 151 located close to the front end of the first cover 15. The engaging portion 122 and the axial hole 132 are respectively exposed. The rear wheel 13 is rotatably engaged between the rear pivotal hole 1132 and the bore 152 located close to the rear end of the first cover 15. The first cover 15 has a second mounting hole 154 defined through the front end thereof. The first and second mounting holes 114, 154 are located corresponding to each other and have the same shape. The first base 11 and the first cover 15 each have even-spaced locking holes 115, 155. Multiple rivets 16 are riveted through the locking holes 115, 155 to connect the first base 11 and the first cover 15. The first cover 15 covers up the middle wheel 14. The ring-shaped resilient member 144 is engaged with the annular groove 143 and contacts the first cover 15 so that when the middle wheel 14 is rotated, a damper is generated by the ring-shaped resilient member 144.

The passive unit 20 includes a second base 21 and a second cover 210 which is mounted to the second base 21. A first wheel 22 and a second wheel 23 are rotatably received in the space between the second base 21 and the second cover 210. The teeth 221 of the first wheel 22 is engaged with teeth 231 of the second wheel 23 and teeth 131 of the rear wheel 13.

The second base 21 has a recessed area 214, a first recess 211 and a second recess 212 defined therein. A third opening 2111 is defined in communication between the recessed area 214 and the first recess 211. The second recess 212 has a bore 213 defined through the bottom thereof. A fourth opening 2121 is defined in communication between the first recess 211 and the second recess 212. The rear end of the active unit 10 is rotatably located in the recessed area 214. The rear recess 113 of the active unit 10 communicates with the first recess 211 via the third opening 2111. The first wheel 22 has a circular second receiving portion 222, and the second wheel 23 has a polygonal engaging portion 232. The recessed area 214 has a bore 215 defined through the bottom thereof. The first and second wheels 22, 23 are respectively and rotatably received in the first and second recesses 211, 212. The first wheel 22 is engaged with the rear wheel 13 via the third opening 2111. The second wheel 23 is engaged with the first wheel 22 via the fourth opening 2121. The second wheel 23 is rotatably engaged between the bore 213 of the second recess 212 and another bore 213 of the second cover 210. Multiple rivets 24 extend through the locking holes 217 to connect the second cover 210 to the second base 21.

A shaft 30 extends through the bore 215 of the recessed area 214 and the axial hole 132 of the rear wheel 13 so that the active unit 10 and the passive unit 20 are pivotable about the shaft 30 to adjust the angle between the active unit 10 and the passive unit 20. The shaft 30 has a head 31 on the top end thereof, and a groove 32 is defined in the lower end thereof. A clip 35 is engaged with the groove 32. The head 31 and the clip 35 are respectively received in the two respective enlarged recesses 216 so as to restrict the shaft 30 from dropping from the bore 215 and the axial hole 132.

As shown in FIGS. 1, 2 and 7, when the users want to pick out the bolt 51 at the object 52, because there is a distance 54 between the two objects 53, the active and passive units 10, 20 can be adjusted an angle so that the passive unit 20 is inserted into the distance to be mounted to the bolt 51. The engaging portion 232 is mounted to the bolt 51, and the two hand tools 40, 41 are respectively connected with the engaging portion 122 and the first mounting hole 114. When rotating the hand tool 40, the front wheel 12 drives the middle wheel 14, the rear wheel 13, the first wheel 22 and the second wheel 23. The bolt 51 is able to be rotated and picked out from the object 52.

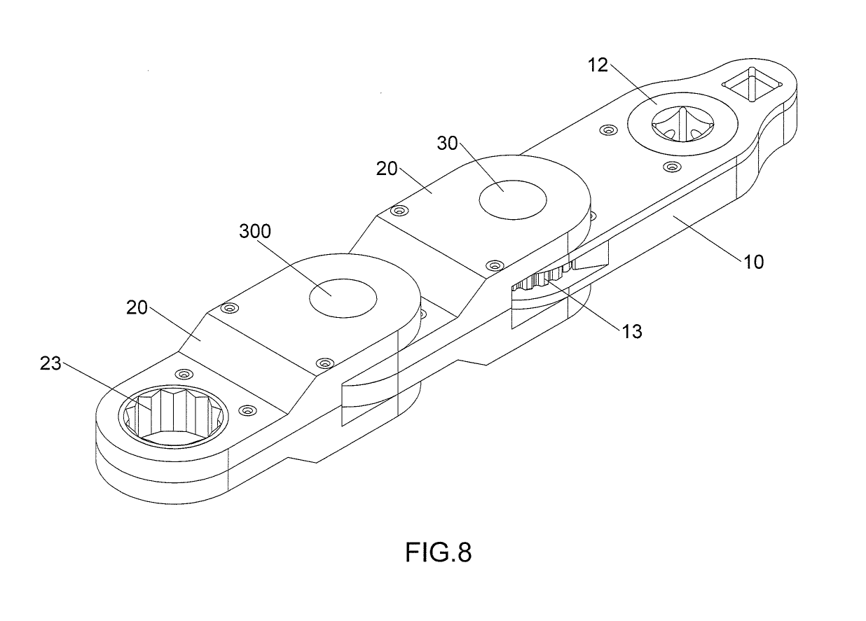

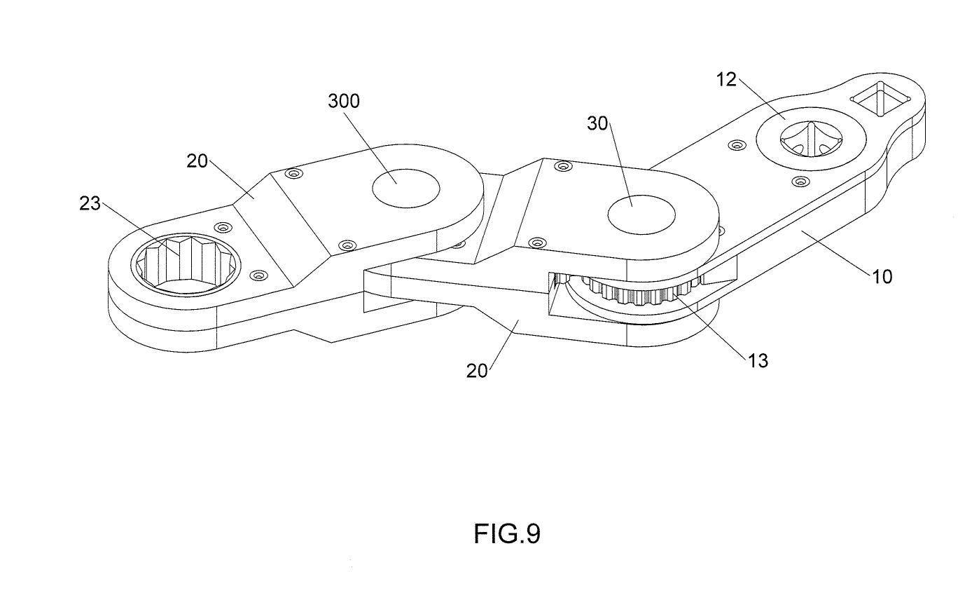

As shown in FIGS. 8 and 9, there are two passive units 20. The second wheel 23 of one of the two passive units 20 is located in the recessed area 214 of the other one of the two passive units 20. A pin 300 extends through the engaging portion 232 of the second wheel 23 and the recessed area 214 to connect the two passive units 20.

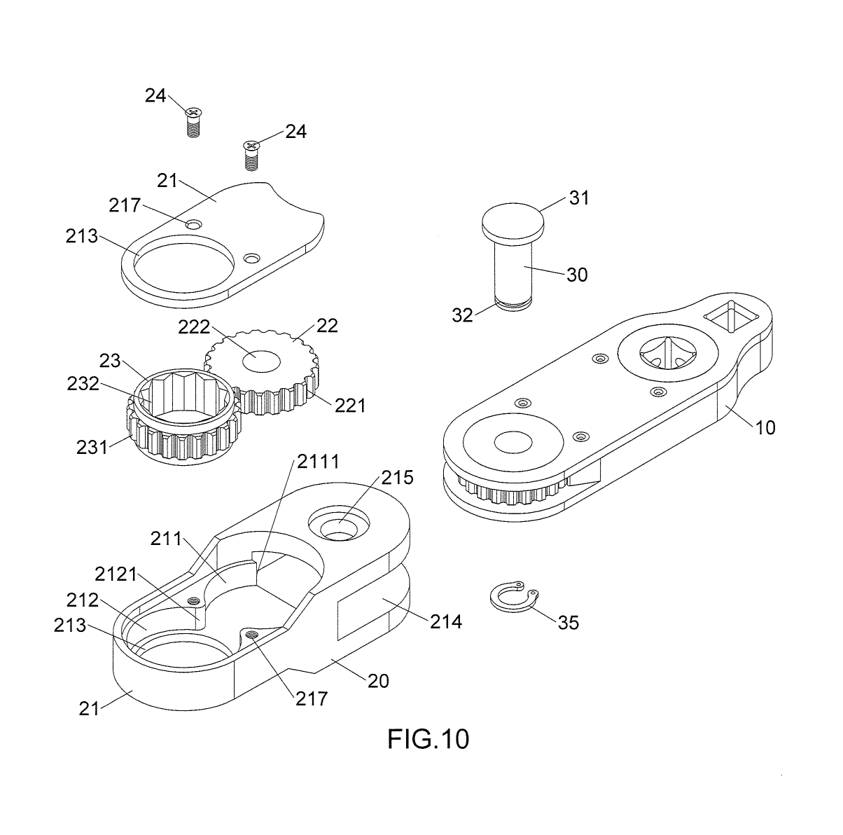

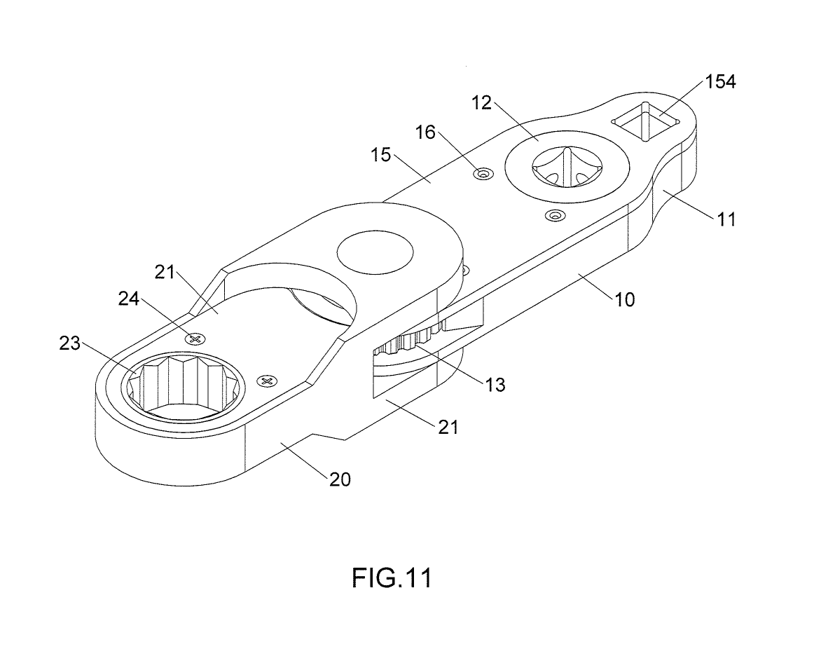

As shown in FIGS. 10 and 11, the second base 21 and the second cover 210 have different shapes. The second base 21 includes two extensions between which the recessed area 214 is located. The second cover 210 includes the bore 213 which is co-axially located corresponding to the second recess 212. The second cover 210 covers the first and second wheels 22, 23 in the second base 21.

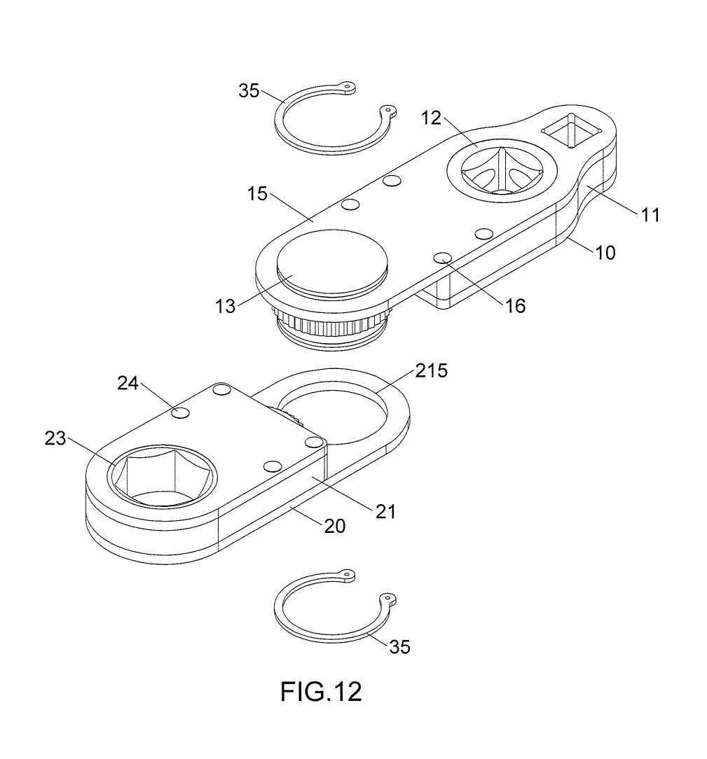

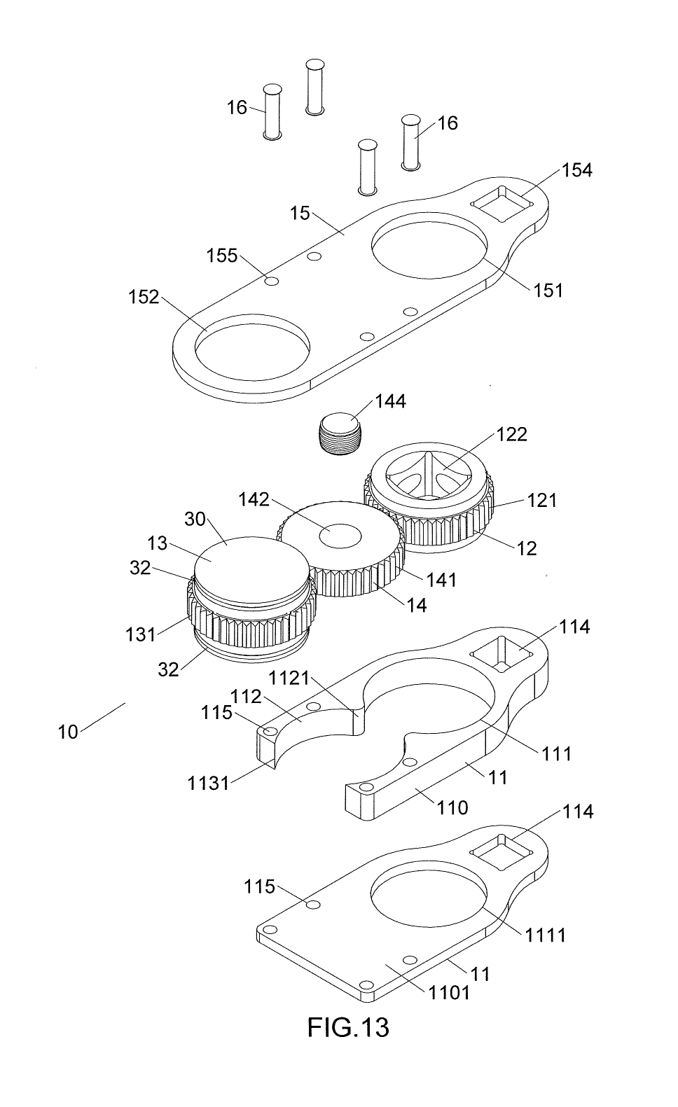

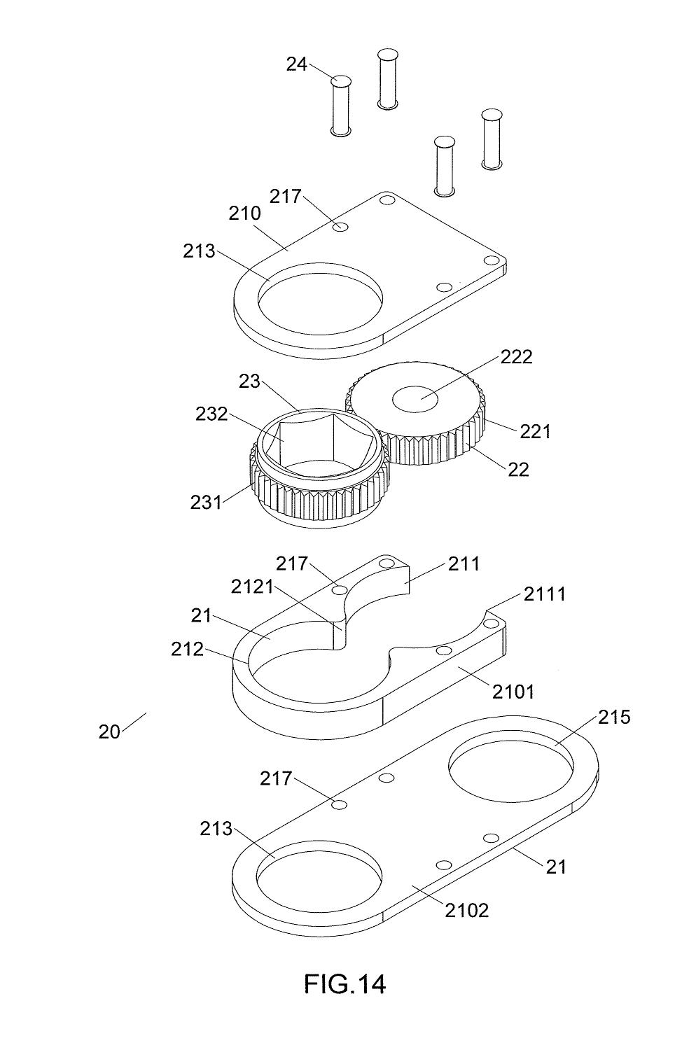

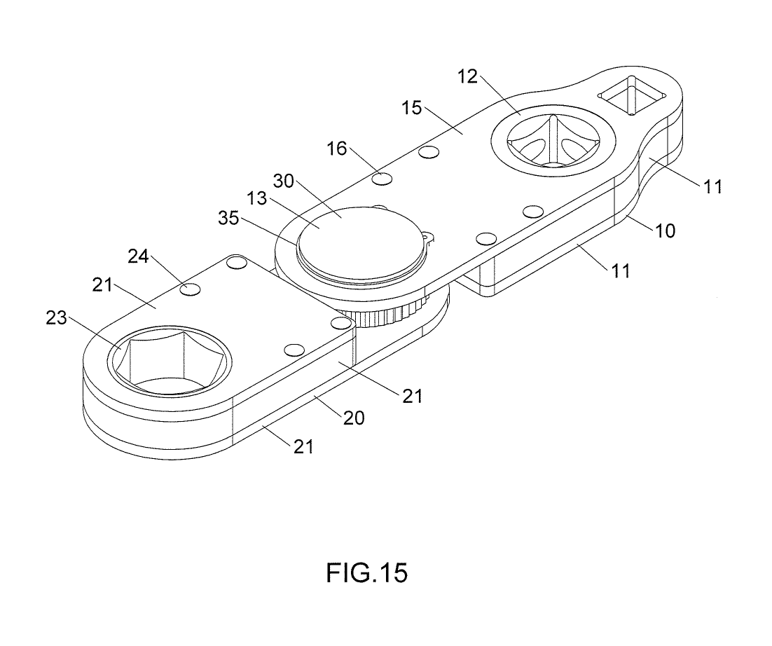

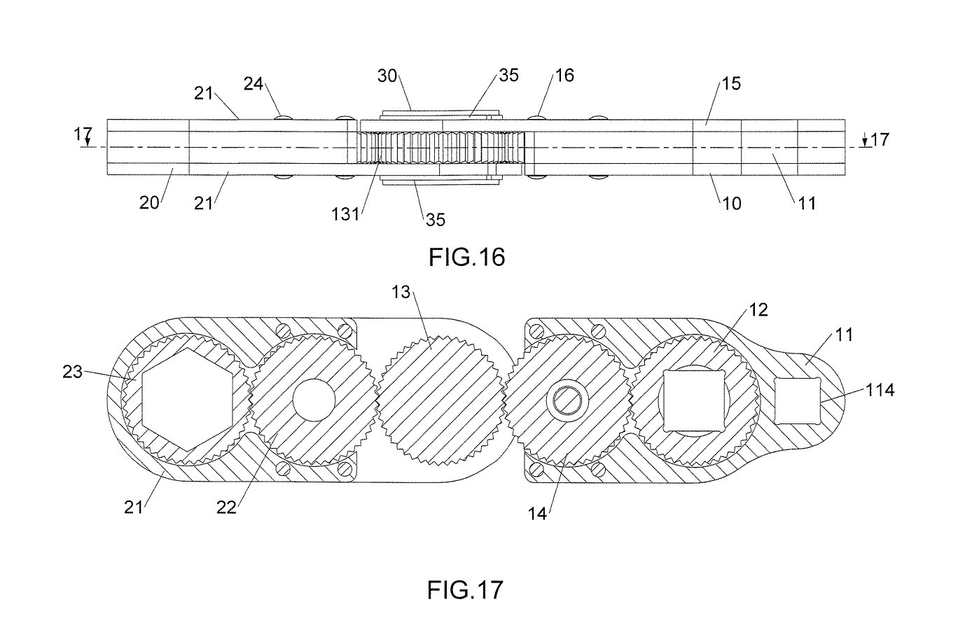

As shown in FIGS. 12 to 17, the first base 11 includes a first base board 110 and a first top part 1101 which is connected to the first base board 110. The first base board 110 includes the front recess 111, the middle recess 112, the first opening 1121 and the second opening 1131. The first top part 1101 includes the front pivotal hole 1111. The first top part 1101 and the first base board 110 each have the first mounting hole 114 and multiple locking holes 115. The ring-shaped resilient member 144 is received in the first receiving portion 142. The rear wheel 13 and the shaft 30 are integrally formed as a one piece. The shaft 30 includes two grooves 32 respectively defined in two ends thereof, and the two grooves 32 are exposed beyond the rear wheel 13. The bore 152 of the first cover 15 is mounted to one end of the shaft 30. The second base 21 includes a second base board 2101 and a second top part 2102 which is connected to the second base board 2101. The rivets 24 extend through the locking holes 217 of the second base 21, the second cover 210, and the second top part 2102. The second base board 2101 includes the first recess 211, the second recess 212, the third opening 2111 and the fourth opening 2121. The second top part 2102 includes the two bores 213, 215, and the two bores 213, 215 are respectively co-axial with the second recess 212 and the recessed area 214. The bore 215 that is co-axial with the recessed area 214 is pivotably connected to the other end of the shaft 30. The rear wheel 13 is engaged with the middle wheel 14 and the first wheel 22 via the second opening 1131 and the third opening 2111, so that the front wheel 12, the middle wheel 14, the rear wheel 13, the first wheel 22 and the second wheel 23 are co-rotated.

In another embodiment, the groove 32 is a threaded portion which is connected with the clip 35. The engaging portion 232 is a rectangular protrusion.

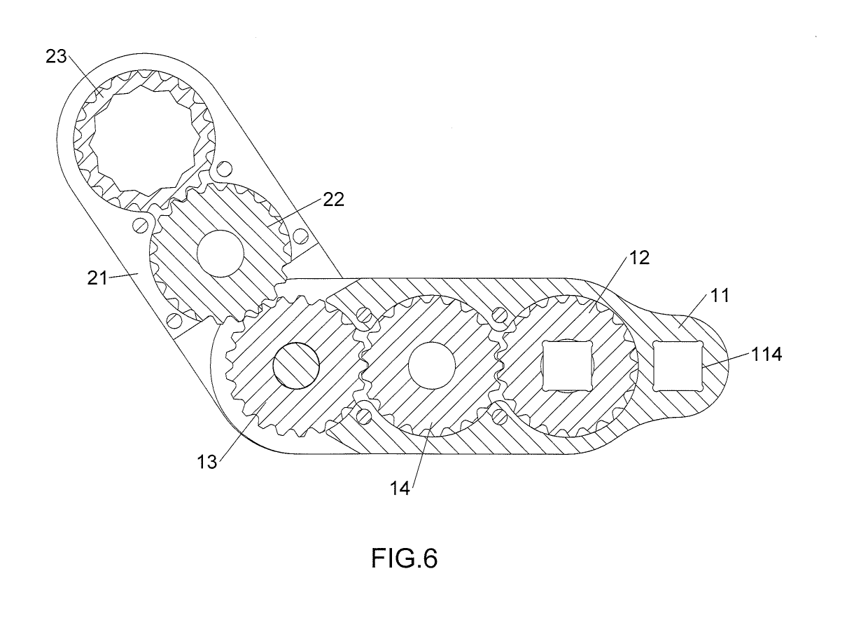

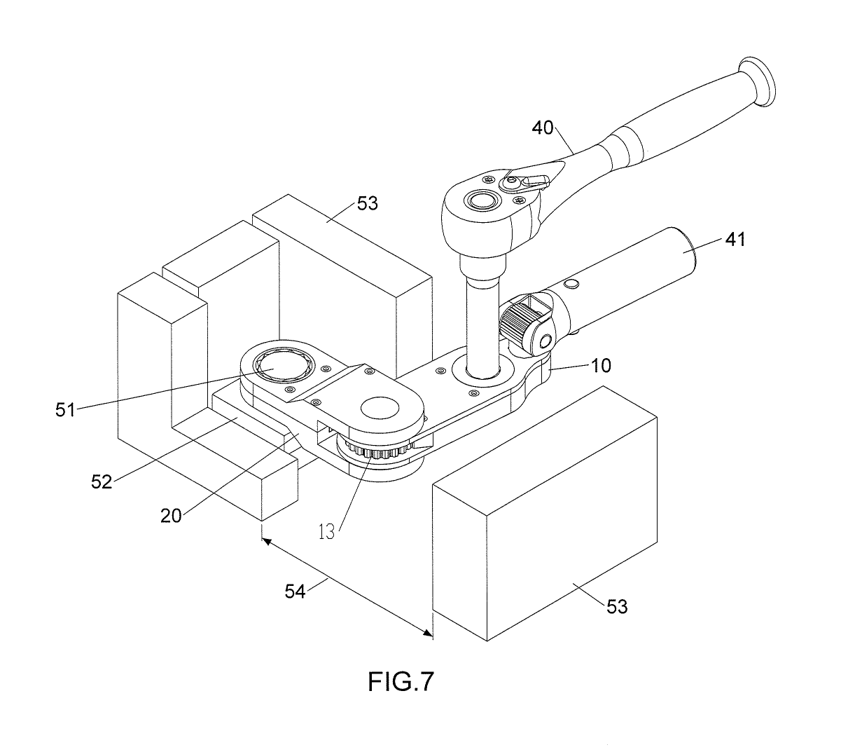

The advantages of the present invention are that the active and passive units 10, 20 are pivotably connected to each other. The front wheel 12, the middle wheel 14, the rear wheel 13, the first wheel 22 and the second wheel 23 are co-rotated. Therefore, the operational status can be easily adjusted to meet different work tasks as shown in FIGS. 6 and 7. The attachment assembly can be cooperated with two hand tools 40, 41 as shown in FIG. 7, the users can easily grip the hand tools 40, 41 to output torques. As shown in FIGS. 8 and 9, there can be cooperated with multiple passive units 20 to extend the length of the combination of the attachment assemblies, and multiple angles can be set to deal with different work requirements.

While we have shown and described the embodiment in accordance with the present invention, it should be clear to those skilled in the art that further embodiments may be made without departing from the scope of the present invention.

What is claimed is:

1. An attachment assembly for being connected with a hand tool, comprising:
an active unit having a first base and a first cover which is mounted to the first base, each of the first base and the first cover having a front end and a rear end, a front wheel, a middle wheel and a rear wheel rotatably received in a space between the first base and the first cover in sequence, the first base having a front recess, a middle recess and a rear recess, the front recess having a front pivotal hole defined through a bottom thereof, a first opening defined in communication between the front and middle recesses, the rear recess opening to the rear end of the first base, a second opening defined in communication between the middle and rear recesses, the rear recess having a rear pivotal hole defined through a bottom thereof, a first mounting hole defined through the front end of the first base, the front recess located between the first mounting hole and the middle recess;
the front wheel, the middle wheel and the rear wheel respectively and rotatably received in the front recess, the middle recess and the rear recess, a polygonal engaging portion defined centrally in the front wheel, the front wheel, the middle wheel and the rear wheel having the same diameter;
the front wheel engaged with the middle wheel via the first opening, the middle wheel engaged with the rear wheel via the second opening, the rear wheel having an axial hole defined centrally therethrough;
the first cover having two bores respectively located close to the front end and the rear end of the first cover, the two bores respectively located corresponding to the front recess and the rear recess, the front wheel rotatably engaged between the front pivotal hole and the bore located close to the front end of the first cover, the rear wheel rotatably engaged between the rear pivotal hole and the bore located close to the rear end of the first cover, the first cover having a second mounting hole defined through the front end thereof, the first and second mounting holes located corresponding to each other and having the same shape;
at least one passive unit including a second base and a second cover which is mounted to the second base, a first wheel and a second wheel rotatably received in a space between the second base and the second cover, the second base having a recessed area, a first recess and a second recess defined therein, a third opening defined in communication between the recessed area and the first recess, the second recess having a bore defined through a bottom thereof, a fourth opening defined in communication between the first recess and the second recess, the rear end of the active unit rotatably located in the recessed area, the rear recess of the active unit communicating with the first recess via the third opening, the recessed area having a bore defined through a bottom thereof, a shaft extending through the bore of the recessed area and the axial hole of the rear wheel, and
the first and second wheels respectively and rotatably received in the first and second recesses, the first wheel engaged with the rear wheel via the third opening, the second wheel engaged with the first wheel via the fourth opening, the second wheel having an engaging portion which are engaged between the bore of the second recess and another bore of the second cover.

2. The attachment assembly as claimed in claim 1, wherein the engaging portion and the first mounting hole have the same specification.

3. The attachment assembly as claimed in claim 1, wherein the first base and the first cover each have even-spaced locking holes, multiple rivets are riveted through the locking holes to connect the first base and the first cover.

4. The attachment assembly as claimed in claim 1, wherein the middle wheel includes a first receiving portion, the first wheel has a second receiving portion, a ring-shaped resilient member is engaged with the first receiving portion.

5. The attachment assembly as claimed in claim 1, wherein the middle wheel includes an annular groove defined in a top thereof, a ring-shaped resilient member is engaged with the annular groove and contacts the first cover.

6. The attachment assembly as claimed in claim 1, wherein the first cover covers up the middle wheel.

7. The attachment assembly as claimed in claim 1, wherein the second base and the second cover have the same shape.

8. The attachment assembly as claimed in claim 1, wherein two enlarged recesses are respectively located in two ends of the bore of the recessed area, the shaft has a head on a top end thereof, and a groove in a lower end thereof, a clip is engaged with the groove, the head and the clip are respectively received in the wo respective enlarged recesses.

9. The attachment assembly as claimed in claim 1, wherein the second base and the second cover are connected to each other by multiple rivets.

10. The attachment assembly as claimed in claim 1, wherein the engaging portion of the second wheel is a polygonal recess or a rectangular protrusion.

11. The attachment assembly as claimed in claim 1, wherein there are two passive units.

12. The attachment assembly as claimed in claim 1, wherein there are two passive units, the second wheel of one of the two passive units is located in the recessed area of the other one of the two passive units, a pin extends through the second wheel and the recessed area to connect the two passive units.

13. The attachment assembly as claimed in claim 1, wherein the second base and the second cover have different shapes, the second base includes two extensions between which the recessed area is located.

14. The attachment assembly as claimed in claim 1, wherein the first base includes a first base board and a first top part which is connected to the first base board, the first base board includes the front recess, the middle recess, the first opening and the second opening, the first top part includes the front pivotal hole, the first mounting hole is defined through the first top part, the rear wheel and the shaft are integrally formed as a one piece, the shaft includes two grooves respectively defined in two ends thereof, the two grooves are exposed beyond the rear wheel, the bore of the first cover mounted to one end of the shaft, the second base includes a second base board and a second top part which is connected to the second base board, the second base board includes the first recess, the second recess, the third opening and the fourth opening, the second top part includes the two bores, the two bores are respectively co-axial with the second recess and the recessed area, the bore that is co-axial with the recessed area is pivotably connected to the other end of the shaft.
